(19) United States
(12) Patent Application Publication
(10) Pub. No.: US 2008/0049073 A1
(43) Pub. Date: Feb. 28, 2008

(54) Inkjet printhead and method of manufacturing the same

(75) Inventors: Moon-chul Lee, Yongin-si (KR); Sang-hyun Kim, Yongin-si (KR); Dong-sik Shim, Yongin-si (KR); Hyung Choi, Yongin-si (KR); Keon Kuk, Yongin-si (KR); Yong-seop Yoon, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/705,457

(22) Filed: Feb. 13, 2007

(30) Foreign Application Priority Data
Aug. 24, 2006 (KR) 2006-80721

(51) Int. Cl. B41J 2/05

(52) U.S. Cl. 347/65

(57) ABSTRACT

An inkjet printhead and a method of manufacturing the same. The inkjet printhead includes a substrate including one or more ink feed holes to supply ink, which penetrates through the substrate, a chamber layer stacked on the substrate and including a plurality of ink chambers, in which the ink supplied from the ink feed hole is filled, a nozzle layer stacked on the chamber layer and including a plurality of nozzles, through which the ink is ejected, and a support member attached on a lower surface of the substrate to support the substrate.

### CROSS-REFERENCE TO RELATED APPLICATIONS

This application claims priority under 35 U.S.C. §119(a) from Korean Patent Application No. 10-2006-0080721, filed on Aug. 24, 2006, in the Korean Intellectual Property Office, the disclosure of which is incorporated herein in its entirety by reference.

### BACKGROUND OF THE INVENTION

1. Field of the Invention

The present general inventive concept relates to an inkjet printhead and a method of manufacturing the same, and particularly, to an inkjet printhead having a robust and reliable structure and a method of manufacturing the inkjet printhead.

2. Description of the Related Art

In general, inkjet printers form images of predetermined colors by ejecting fine droplets of ink from an inkjet printhead onto desired positions of a printing medium. Inkjet printers can be classified as shuttle type inkjet printers, in which the inkjet printhead performs a printing operation while reciprocating in a direction perpendicular to a conveying direction of the printing medium, and line printing type inkjet printers, which includes an array printhead having a size corresponding to a width of the printing medium in order to perform the printing operation at high speed. The array printhead includes a plurality of inkjet printheads arranged in a predetermined pattern. The line printing type inkjet printer can perform the printing operation at a high speed because the printing operation is performed by conveying the printing media in a state where the array printhead is fixed.

There are two mechanisms to eject ink droplets in the inkjet printhead. One is a thermal inkjet printhead that ejects the ink droplets using an expanding force of bubbles after generating bubbles in the ink using a thermal source, and the other is a piezoelectric inkjet printhead that ejects the ink droplets using a pressure applied onto the ink which is caused by a deformation of a piezoelectric material.

The ink droplet ejecting mechanism of the thermal inkjet printhead will be described in more detail as follows. When pulse current flows on a heater that is formed of a heating element, the heater generates heat, and thus, the ink adjacent to the heater is instantly heated to a temperature of about 300° C. Accordingly, the ink boils and generates bubbles, and the generated bubbles expand to press the ink filled in an ink chamber. Therefore, the ink around nozzles is ejected out of the ink chamber through the nozzles in a shape of droplet.

FIG. 1 is a schematic cross-sectional view illustrating a conventional thermal inkjet printhead. Referring to FIG. 1, the conventional inkjet printhead includes a substrate 10 on which a plurality of material layers are formed, a chamber layer 20 stacked on the substrate 20, and a nozzle layer 30 stacked on the chamber layer 20. In the chamber layer 20, a plurality of ink chambers 22, in which ink that is to be ejected is filled, are formed. In addition, the nozzle layer 30 includes nozzles 32, through which the ink is ejected. In addition, an ink feed hole 11 for supplying the ink into the ink chambers 22 penetrates through the substrate 10. Also, a plurality of restrictors 24 connecting the ink chambers 22 and the ink feed hole 11 are formed in the chamber layer 20.

The substrate 10 is generally a silicon substrate. An insulating layer 12 for insulating the substrate 10 from a heater 14 is formed on the substrate 10, and the insulating layer 12 can be formed of a silicon oxide material. In addition, heaters 14 are formed on the insulating layer 12 for heating the ink and generating ink bubbles. Electrodes 16 are formed on the heaters 14 for supplying current to the heaters 14. A passivation layer 18 is formed on surfaces of the heaters 14 and the electrodes 16 for protecting them, and the passivation layer 18 can be formed of a silicon oxide material or a silicon nitride material. In addition, an anti-cavitation layer 19 protecting the heaters 14 from a cavitation force that is generated when the bubbles are extinguished is formed on the passivation layer 18, and the anti-cavitation layer 19 is generally formed of Ta.

However, according to the conventional inkjet printhead having the above structure, since the ink feed hole 11 penetrates through the substrate 10 in order to supply the ink directly from an ink cartridge containing the ink, the substrate 10 becomes weak and may be deformed easily. Therefore, stress may be concentrated on the nozzle layer 30 stacked on the substrate 10, and thus, the nozzle layer 30 may be deformed. In addition, when the ink cartridge is coupled to a lower surface of the substrate 10 of the above conventional inkjet printhead, the nozzle layer 30 may be damaged or twisted. Also, since the substrate 10 and the ink cartridge are respectively formed of materials having different thermal expansion coefficients from each other, an assembly of the substrate 10 and the ink cartridge may be thermally deformed. The weakness of the conventional inkjet printhead becomes worse when a length of the inkjet printhead increases, and thus, the problem of the weak inkjet printhead becomes worse in the line printing type inkjet printer that is recently being developed for printing at a high speed.

### SUMMARY OF THE INVENTION

The present general inventive concept provides a thermally actuated inkjet printhead having a robust and reliable structure, and a method of manufacturing the inkjet printhead.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing an inkjet printhead including a substrate including one or more ink feed holes to supply ink, which penetrates through the substrate, a chamber layer stacked on the substrate and including a plurality of ink chambers, in which the ink supplied from the ink feed hole is filled, a nozzle layer stacked on the chamber layer and including a plurality of nozzles, through which the ink is ejected, and a support member attached on a lower surface of the substrate to support the substrate.

The support member may include one or more penetration holes to communicate with the ink feed holes.

The penetration holes may be formed in parallel with the ink feed hole.

At least one support beam may be disposed between the penetration holes.

The support member may be formed of the same material as that of the substrate.

The ink feed hole may penetrate the substrate perpendicularly to the surface of the substrate.

The inkjet printhead may include an insulating layer formed on the surface of the substrate.

The inkjet printhead may include a plurality of heaters formed on the insulating layer to heat the ink in the ink chambers and to generate ink bubbles, and a plurality of electrodes formed on the heaters to supply electric current to the heaters.

The inkjet printhead may include a passivation layer formed on surfaces of the heaters and the electrodes.

The inkjet printhead may include an anti-cavitation layer formed on the passivation layer that is located on the heaters to protect the heaters from a cavitation force.

The chamber layer may include a plurality of restrictors that connect the ink feed holes to the ink chambers.

The foregoing and/or other aspects and utilities of the present general inventive concept are also achieved by providing a method of manufacturing an inkjet printhead, the method including preparing a substrate, stacking a chamber layer including a plurality of ink chambers on the substrate, stacking a nozzle layer including a plurality of nozzles on the chamber layer, forming one or more ink feed holes that penetrate the substrate in order to supply ink to the ink-chambers, and attaching a support member on a lower surface of the substrate for supporting the substrate.

The attaching of the support member may include attaching the support member onto the lower surface of the substrate using a polymer bonding method.

The foregoing and/or other aspects and utilities of the present general inventive concept are also achieved by providing an image forming apparatus including an inkjet printer having a substrate defining one or more ink feed holes to supply ink, a chamber layer defining a plurality of ink chambers disposed on a top surface of the substrate to hold the ink supplied from the ink feed holes, a nozzle layer disposed on the chamber layer, defining a plurality of nozzles to eject the supplied ink, and a support member disposed on a bottom surface of the substrate to support the substrate, and an ink cartridge connected to the inkjet printhead to supply ink to the substrate through the support member.

The support member may include a plurality of penetration holes that correspond to the ink feed holes.

The support member may include at least one support beam disposed between the penetration holes.

The inkjet printhead may be one of a thermal type inkjet printhead and a piezoelectric type inkjet printhead.

The support member may be directly attached to the bottom surface of the substrate without any intervening layers.

The support beam may be disposed partially blocking at least one ink feed holes on the substrate.

The foregoing and/or other aspects and utilities of the present general inventive concept are also achieved by providing a method of manufacturing an inkjet printhead of an image forming apparatus, the method including preparing a substrate defining one or more ink feed holes to supply ink, forming a chamber layer defining a plurality of ink chambers on a top surface of the substrate to hold the ink supplied from the ink feed holes, forming a nozzle layer disposed on the chamber layer, defining a plurality of nozzles to eject the supplied ink, and forming a support member disposed on a bottom surface of the substrate to support the substrate.

The support member may include a plurality of penetration holes that correspond to the ink feed holes.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a schematic cross-sectional view of a conventional inkjet printhead;

FIG. 2 illustrates an exploded perspective view of an inkjet printhead according to an embodiment of the present general inventive concept;

FIG. 3 illustrates a schematic plan view of the inkjet printhead of FIG. 2;

FIG. 4 illustrates an expanded view of part A of FIG. 3;

FIG. 5 illustrates a cross-sectional view of the printhead taken along line V-V′ of FIG. 4; and

FIGS. 6 through 12 are views illustrating processes to manufacture the inkjet printhead of FIGS. 2-5.

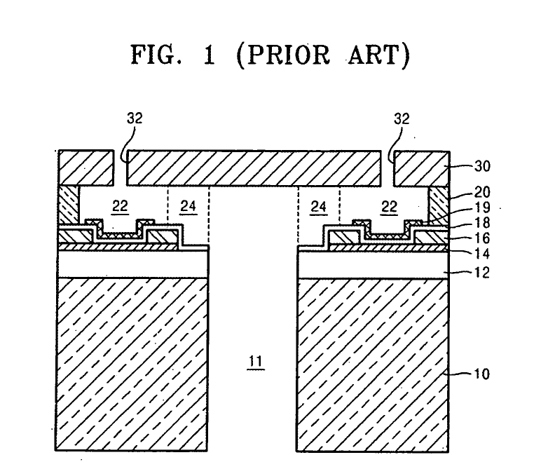

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout, and the thicknesses of layers and regions are exaggerated for clarity. It will also be understood that when a layer is referred to as being “on” another layer or substrate, it can be directly on the other layer or substrate, or intervening layers may also be present. The embodiments are described below in order to explain the present general inventive concept by referring to the figures.

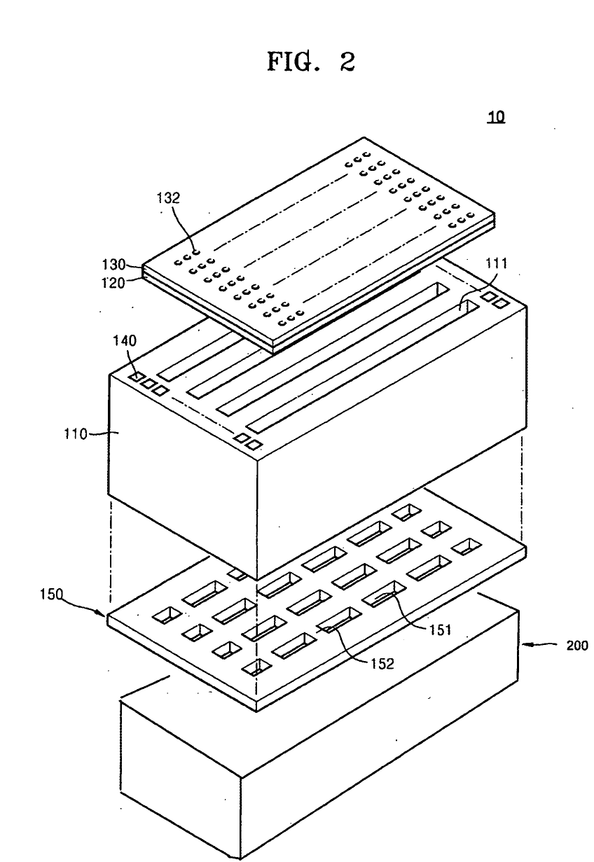

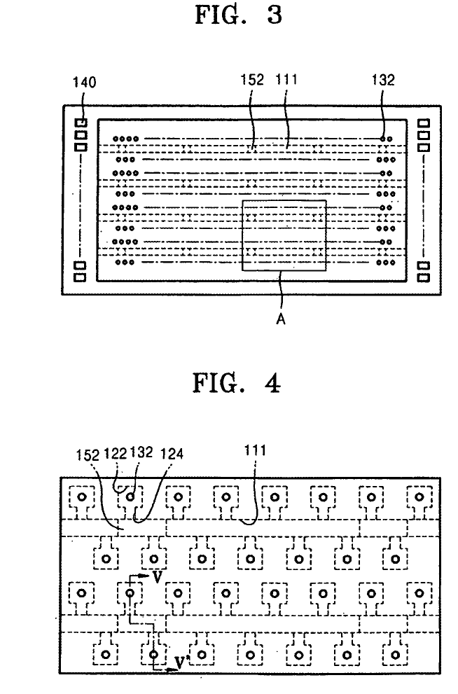

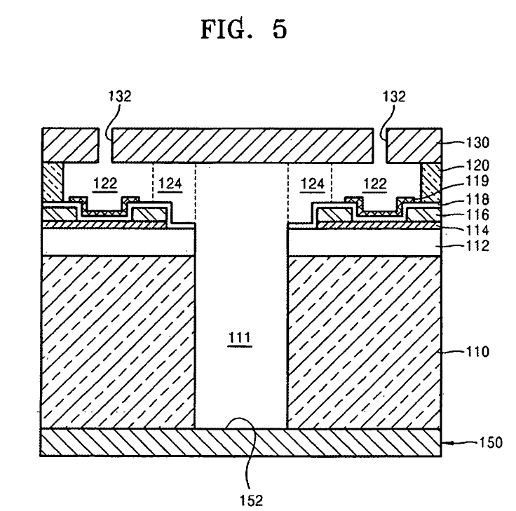

FIG. 2 illustrates an exploded perspective view of an inkjet printhead 100 usable in an image forming apparatus 10 according to an embodiment of the present general inventive concept, and FIG. 3 illustrates a schematic plan view of the inkjet printhead of FIG. 2. FIG. 4 illustrates an expanded view of part A of FIG. 3, and FIG. 5 illustrates a cross-sectional view of the printhead taken along line V-V′ of FIG. 4.

Referring to FIGS. 2 through 5, the inkjet printhead 100 according to an embodiment of the present general inventive concept may include a substrate 110, a chamber layer 120 stacked on the substrate 110, a nozzle layer 130 stacked on the chamber layer 120, and a support member 150 attached onto a lower surface of the substrate 110. The image forming apparatus may have the inkjet printhead 100, an ink cartridge 200, and a conventional printing unit to print an image on a print medium using the inkjet printhead 100 and the ink cartridge 200.

The substrate 110 may be generally a silicon wafer. One or more ink feed holes 111 penetrate through the substrate 110 in order to supply ink. Here, the ink feed holes 111 may penetrate the substrate 110 perpendicularly to a surface of the substrate 110, and may be arranged in parallel with each other. In a color inkjet printer, inks of yellow (Y), magenta (M), cyan (C), and black (K) colors stored in an ink cartridge (not illustrated) coupled to the inkjet printhead are supplied to ink chambers 122 respectively through the ink feed holes 111. While in the present exemplary embodiment four ink feed holes 111 are formed in the substrate 110, as illustrated in FIG. 2, the present general inventive concept is not limited thereto. That is, one ink feed hole 111 can be formed in the substrate 110, or alternatively, a variety of numbers of ink feed holes 111 can be formed in the substrate 110.

As illustrated in FIG. 5, an insulating layer 112 can be formed on an upper surface of the substrate 110 in order to insulate the substrate 110 from heaters 114. The insulating layer 112 can be formed of, for example, a silicon oxide material. The plurality of heaters 114 are formed on an upper surface of the insulating layer 112 in order to heat the ink in the ink chambers 122 and generate ink bubbles. The heater 114 may be formed of a heating resistive material, for example, an alloy of tantalum-aluminum, tantalum nitride, titanium nitride, or tungsten silicide. In addition, an electrode 116 is formed on each of the heaters 114. The electrode 116 supplies an electric current to the heater 114, and thus, is formed of a material having a high electric conductivity. The electrode 116 can be formed of, for example, Al, Al alloy, Au, or Ag.

A passivation layer 118 can be further formed on upper surfaces of the heaters 114 and the electrodes 116. The passivation layer 118 protects the heaters 114 and the electrodes 116 from being oxidized or being corroded due to the contact to the ink. The passivation layer 118 can be formed of, for example, silicon nitride or silicon oxide. In addition, an anti-cavitation layer 119 can be formed on the passivation layer 118 forming bottoms of the ink chambers 122, that is, on the passivation layer 118 located on the heaters 114. The anti-cavitation layer 119 protects the heaters 114 from a cavitation force that is generated when the bubbles are extinguished. The anti-cavitation layer 119 can be formed of Ta, for example.

The chamber layer 120 can be stacked on the passivation layer 118. The chamber layer 120 includes the plurality of ink chambers 122, in which the ink that is to be ejected is filled. In addition, the chamber layer 120 can further include a plurality of restrictors 124 that connect the ink feed holes 111 to the ink chambers 122. Here, the ink chambers 122 are located on the heaters 114. The chamber layer 120 can be formed of, for example, a polymer. In addition, the nozzle layer 130 is stacked on the chamber layer 120. A plurality of nozzles 132, through which the ink in the ink chambers 122 is ejected, are formed in the nozzle layer 130. The nozzles 132 are located on the ink chambers 122. The nozzle layer 130 can be formed of, for example, a polymer. In FIGS. 2 and 3, reference numeral 140 denotes a bonding pad to transmit an external electric signal to each of the electrodes.

The support member 150 is attached onto a lower surface of the substrate 110. The support member 150 supports the substrate 110 so as to prevent the substrate 110, through which the ink feed holes 111 penetrate, from being deformed. One or more penetration holes 151 to communicate with the ink feed holes 111 may be formed in the support member 150. Here, the penetration holes 151 can be arranged in parallel with the ink feed holes 111. However, the present general inventive concept is not limited thereto, and the penetration holes 151 can be arranged in various patterns. In addition, at least one support beam 152 is disposed between the penetration holes 151. According to the current embodiment, the support member 150 may be formed of the same material as the substrate 110. For example, the support member 150 can be formed of the silicon. When the support member 150 is formed of the same material as that of the substrate 110, a thermal deformation problem generated due to a difference of thermal expansion coefficients in the conventional inkjet printhead can be solved.

An ink cartridge 200 is assembled to a lower surface of the support member 150 in the inkjet printhead having the above structure. The ink contained in the ink cartridge 200 is supplied to the ink feed holes 111 through the penetration holes 151 in the support member 150, and the ink supplied to the ink feed holes 111 is filled in each of the ink chambers 122 through the restrictors 124.

As described above, according to the inkjet printhead of the current embodiment, the support member 150 is attached to the lower surface of the substrate 110, through which the ink feed holes 111 penetrate, to support the substrate 110, and thus, the deformation of the substrate 110 and the ink feed holes 111 can be prevented. In addition, the concentration of stress in the nozzle layer 130 that is stacked on the substrate 110 can be reduced, and thus, the deformation or damage of the nozzle layer 130 can be prevented.

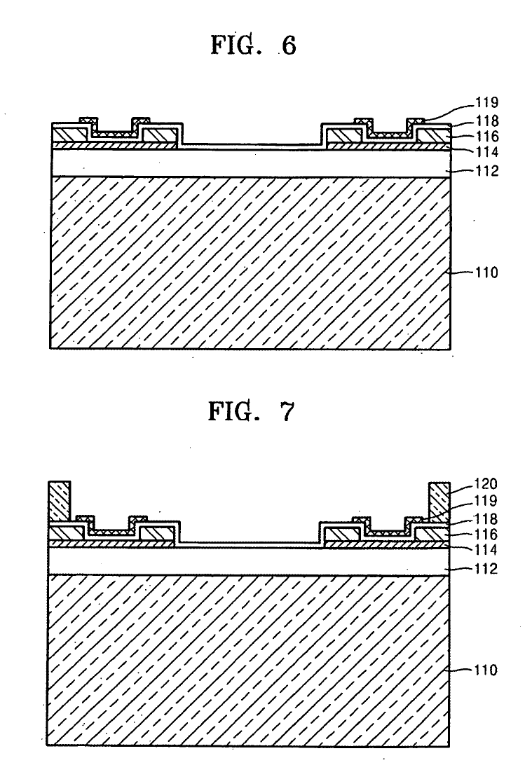

Hereinafter, a method of manufacturing the inkjet printhead according to an embodiment of the present general inventive concept will be described. FIGS. 6 through 12 are view illustrating processes to manufacture the inkjet printhead illustrated in FIGS. 2-5. Hereinafter, a case where one ink feed hole is formed in the substrate will be described as an example. However, the present general inventive concept is not limited thereto, and a different number of ink feed holes may be formed on the substrate. Furthermore, while the exemplary embodiments of FIGS. 2-12 illustrate a thermal inkjet printhead, the present general inventive concept is not limited thereto. Thus, the method and apparatus describe herein may also be applicable to piezoelectric inkjet printheads without departing from the principles and spirit of the general inventive concept.

Referring to FIG. 6, the substrate 110 is prepared. In general, a silicon substrate can be used as the substrate 110. In addition, the insulating layer 112 is formed on the substrate 110 to a predetermined thickness. The insulating layer 112 insulates the substrate 110 from the heater 114, and can be formed of silicon oxide. In addition, the heaters 114 are formed on the insulating layer 112 to heat the ink and to generate ink bubbles. The heaters 114 can be formed by depositing a heating resistive material such as an alloy of tantalum-aluminum, tantalum nitride, titanium nitride, or tungsten silicide on the insulating layer 112, and then, by patterning the deposited material. In addition, the electrodes 116 are formed on the heaters 114 to supply the electric current. The electrodes 116 can be formed by depositing a metal material having high electric conductivity, for example, Al, Al alloy, Au, or Ag, on the heaters 114, and then, by patterning the deposited metal. Then, the passivation layer 118 can be formed on the insulating layer 112 so as to cover the heaters 114 and the electrodes 116. The passivation layer 118 protects the heaters 114 and the electrodes 116 from being oxidized or corroded due to the contact to the ink. The passivation layer 118 can be formed of, for example, silicon oxide or silicon nitride. In addition, the anti-cavitation layer 119 can be further formed on the passivation layer 118 located on the heaters 114, that is, on the passivation layer 118 forming bottoms of the ink chambers (122 of FIG. 13) that will be described later. The anti-cavitation layer 119 protects the heaters 114 from the cavitation force that is generated when the bubbles are extinguished. The anti-cavitation layer 119 can be formed by depositing, for example, Ta on the passivation layer 118, and then, patterning the deposited Ta.

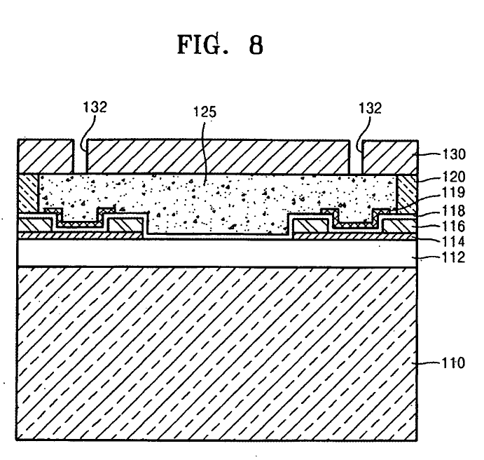

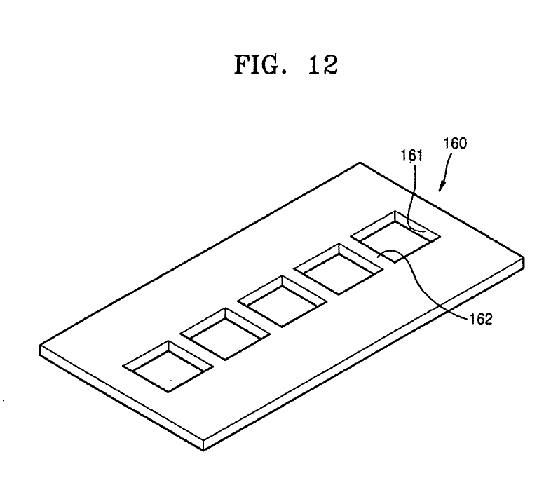

Referring to FIG. 7, the chamber layer 120 is stacked on the passivation layer 118. The chamber layer 120 can be formed by depositing, for example, polymer on entire surface of the resultant of FIG. 6 to a predetermined thickness, and patterning the polymer. Accordingly, a plurality of ink chambers 122, in which the ink that is to be ejected is filled, are formed in the chamber layer 120. Here, each of the ink chambers 122 is located on each of the heaters 114. In addition, the chamber layer 120 may further include a plurality of restrictors 124, through which the ink can be supplied from the ink feed holes 111 (see FIG. 11) to the ink chambers 122.

Referring to FIG. 8, a sacrificial layer 125 is formed to fill out the ink chambers 122 and the restrictors 124. After forming the sacrificial layer 125, a process of planarizing the upper portion of the sacrificial layer 125 using a chemical mechanical polishing (CMP) method, or the like, may be further performed. In addition, the nozzle layer 130 is formed on the sacrificial layer 125 and the chamber layer 120. The nozzle layer 130 can be formed by depositing, for example, polymer on the sacrificial layer 125 and the chamber layer 120 to a predetermined thickness, and patterning the polymer. Accordingly, a plurality of nozzles 132, through which the ink is ejected, are formed in the nozzle layer 130. Each of the nozzles 132 is located on each of the ink chambers 122, and the upper surface of the sacrificial layer 125 is exposed through the nozzles 132.

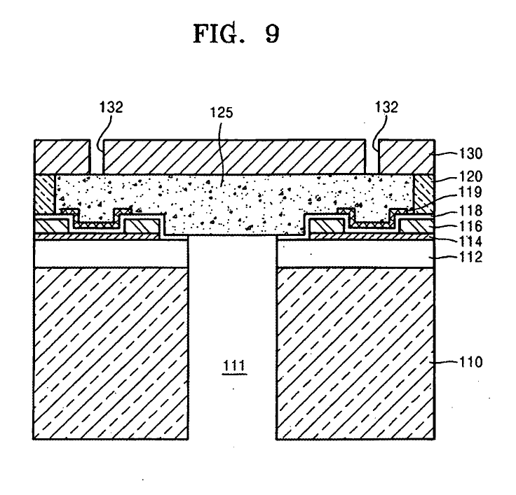

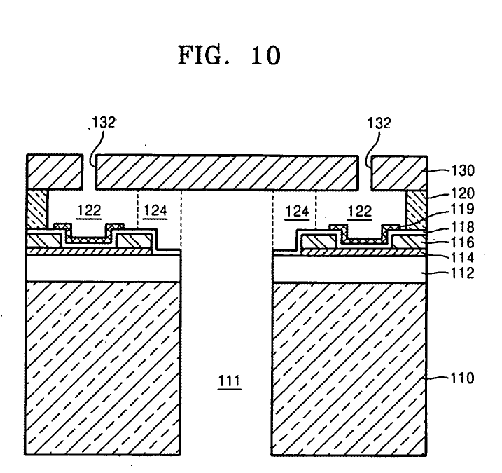

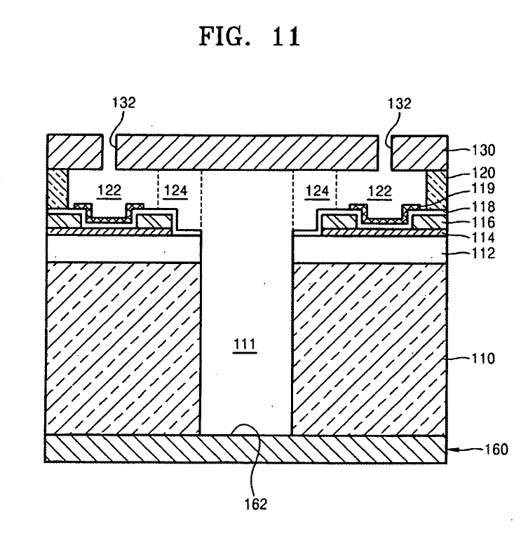

Referring to FIG. 9, the ink feed hole 111 to supply the ink is formed by etching the rear surface of the substrate 110. The ink feed hole 111 can be formed by etching the substrate 110 and the insulating layer 112 until the sacrificial layer 125 is exposed. Here, the ink feed hole 111 can be formed perpendicularly to the surface of the substrate 110 with a predetermined width. The ink feed hole can have various shapes, for example, a shape having narrower width on an upper portion thereof than a lower portion. In addition, referring to FIG. 10, when an etchant is injected through the ink feed hole 111 and the nozzles 132, the sacrificial layer 125 filled in the ink chambers 122 and the restrictors 124 is removed.

Referring to FIG. 11, a support member 160 is attached to a lower surface of the substrate 110, in which the ink feed hole 111 is formed. FIG. 12 is a perspective view of the support member 160 of FIG. 11. Referring to FIG. 12, the support member 160 may include one or more penetration holes 161 to communicate with the ink feed hole 111 in parallel with the ink feed hole 111. The penetration holes 161 can be formed in various shapes besides the shape illustrated in FIG. 12. In addition, at least one support beam 162 is disposed between the penetration holes 161. The support member 160 can be formed of the same material as that of the substrate 110, for example, the silicon. The support member 160 can be fabricated by forming an etching mask on a plate formed of silicon having a predetermined thickness, and etching the plate to form the penetration holes 161. The support member 160 can be attached onto the lower surface of the substrate 110 using, for example, a polymer bonding method. In addition, various bonding methods can be used to attach the support member 160 onto the substrate 110.

As described above, according to the present general inventive concept, the support member to support the substrate is attached on the lower surface of the substrate, through which the ink feed hole penetrates, and thus, the deformation of the substrate and the ink feed hole can be reduced. In addition, the concentration of stress in the nozzle layer that is stacked on the substrate can be prevented, and thus, the deformation of the nozzle layer can be reduced, and the damage or twisting of the nozzle layer during the assembling process of the ink cartridge to the substrate can be prevented. In addition, since the support member is formed of the same material as that of the substrate, the thermal deformation problem generated due to the difference of the thermal expansion coefficients in the conventional inkjet printhead can be solved. According to the inkjet printhead of the present general inventive concept, a reproducible ink ejecting property can be obtained through a robust and reliable structure of an inkjet printhead, and a deformation of the inkjet printhead during an assembling process with an ink cartridge can be prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printhead, comprising:
a substrate including one or more ink feed holes to supply ink, which penetrates through the substrate;
a chamber layer stacked on the substrate and including a plurality of ink chambers, in which the ink supplied from the ink feed hole is filled;
a nozzle layer stacked on the chamber layer and including a plurality of nozzles, through which the ink is ejected; and
a support member attached on a lower surface of the substrate to support the substrate.

2. The inkjet printhead of claim 1, wherein the support member comprises one or more penetration holes to communicate with the ink feed holes.

3. The inkjet printhead of claim 2, wherein the penetration holes are formed in parallel with the ink feed hole.

4. The inkjet printhead of claim 2, wherein at least one support beam is disposed between the penetration holes.

5. The inkjet printhead of claim 1, wherein the support member is formed of the same material as that of the substrate.

6. The inkjet printhead of claim 5, wherein the substrate and the support member are formed of silicon.

7. The inkjet printhead of claim 1, wherein the ink feed hole penetrates the substrate perpendicularly to the surface of the substrate.

8. The inkjet printhead of claim 1, further comprising:
an insulating layer formed on the surface of the substrate.

9. The inkjet printhead of claim 8, further comprising:
a plurality of heaters formed on the insulating layer to heat the ink in the ink chambers and to generate ink bubbles; and
a plurality of electrodes formed on the heaters to supply electric current to the heaters.

10. The inkjet printhead of claim 9, further comprising:
a passivation layer formed on surfaces of the heaters and the electrodes.

11. The inkjet printhead of claim 10, further comprising:
an anti-cavitation layer formed on the passivation layer that is located on the heaters to protect the heaters from a cavitation force.

12. The inkjet printhead of claim 1, wherein the chamber layer comprises a plurality of restrictors that connect the ink feed holes to the ink chambers.

13. A method of manufacturing an inkjet printhead, the method comprising:
preparing a substrate;
stacking a chamber layer including a plurality of ink chambers on the substrate;
stacking a nozzle layer including a plurality of nozzles on the chamber layer;
forming one or more ink feed holes that penetrate the substrate in order to supply ink to the ink chambers; and
attaching a support member on a lower surface of the substrate to support the substrate.

14. The method of claim 13, wherein the support member includes one or more penetration holes to communicate with the ink feed holes.

15. The method of claim 14, wherein the penetration holes are formed in parallel with the ink feed holes.

16. The method of claim 14, wherein at least one support beam is disposed between the penetration holes.

17. The method of claim 13, wherein the attaching of the support member comprises attaching the support member onto the lower surface of the substrate using a polymer bonding method.

18. The method of claim 13, wherein the support member is formed of the same material as that of the substrate.

19. The method of claim 13, wherein the substrate and the support member are formed of silicon.

20. The method of claim 13, further comprising:
forming an insulating layer on the substrate;
forming a plurality of heaters on the insulating layer; and
forming a plurality of electrodes on the plurality of heaters, after preparing the substrate.

21. The method of claim 20, further comprising:
forming a passivation layer covering the heaters and the electrodes, after forming the plurality of electrodes.

22. The method of claim 21, further comprising:
forming an anti-cavitation layer on the passivation layer that is located on upper portions of the heaters, after forming the passivation layer.

23. The method of claim 13, further comprising:
forming a sacrificial layer to fill out the ink chambers, after forming the chamber layer.

24. The method of claim 23, further comprising:
removing the sacrificial layer after forming the ink feed holes.

25. An image forming apparatus comprising:
an inkjet printer having a substrate defining one or more ink feed holes to supply ink, a chamber layer defining a plurality of ink chambers disposed on a top surface of the substrate to hold the ink supplied from the ink feed holes, a nozzle layer disposed on the chamber layer, defining a plurality of nozzles to eject the supplied ink, and a support member disposed on a bottom surface of the substrate to support the substrate; and
an ink cartridge connected to the inkjet printhead to supply ink to the substrate through the support member.

26. The image forming apparatus of claim 25, wherein the support member comprises a plurality of penetration holes that correspond to the ink feed holes.

27. The image forming apparatus of claim 26, wherein the support member comprises at least one support beam disposed between the penetration holes.

28. The image forming apparatus of claim 25, wherein the inkjet printhead is one of a thermal type inkjet printhead and a piezoelectric type inkjet printhead.

29. The image forming apparatus of claim 25, wherein the support member is directly attached to the bottom surface of the substrate without any intervening layers.

30. The image forming apparatus of claim 27, wherein the support beam is disposed partially blocking at least one ink feed holes on the substrate.

31. A method of manufacturing an inkjet printhead of an image forming apparatus, the method comprising:
preparing a substrate defining one or more ink feed holes to supply ink;
forming a chamber layer defining a plurality of ink chambers on a top surface of the substrate to hold the ink supplied from the ink feed holes;
forming a nozzle layer disposed on the chamber layer, defining a plurality of nozzles to eject the supplied ink; and
forming a support member disposed on a bottom surface of the substrate to support the substrate.

32. The method of claim 31, wherein the support member comprises a plurality of penetration holes that correspond to the ink feed holes.
